(19) United States
(12) Patent Application Publication
(10) Pub. No.: US 2025/0229928 A1
(43) Pub. Date: Jul. 17, 2025

(54) CONTAINER-FEEDING DEVICE AND METHOD FOR FEEDING CONTAINERS TO A METERING AND/OR FILLING DEVICE

(71) Applicant: Ampack GmbH, Königsbrunn (DE)

(72) Inventor: Michael Leutenmayr, Dinkelscherben (DE)

(21) Appl. No.: 18/849,619

(22) PCT Filed: Mar. 29, 2023
(86) PCT No.: PCT/EP2023/058162

§ 371 Date: Sep. 23, 2024

(30) Foreign Application Priority Data
Mar. 30, 2022 (DE) 10 2022 107 552.4

(51) Int. Cl. B65B 43/14; B65B 43/42

(52) U.S. Cl. CPC B65B 43/145; B65B 43/42

(57) ABSTRACT

A container feeding device, in particular a cup feeding device, for feeding containers, in particular cups, to a metering and/or filling device, includes at least one magazine unit for receiving a plurality of containers, in particular a plurality of container stacks, and includes at least one lift unit for a transport of the containers, in particular the container stacks, along a lifting direction of the lift unit, in particular to a plane that is situated higher than a transport surface of a transport element of the magazine unit. The container feeding device further includes at least one movement unit which supports the lift unit such that it is movable, in particular drivably movable, relative to the magazine unit, in particular relative to a frame of the magazine unit, along a movement axis of the lift unit that runs transversal, in particular at least substantially perpendicular, to the lifting direction.

### CROSS-REFERENCE TO RELATED APPLICATIONS

This patent application is a U.S. national stage application of international patent application PCT/EP2023/058162, filed on Mar. 29, 2023, which is based on and claims priority to German patent application DE 10 2022 107 552.4, filed on Mar. 30, 2022, the contents of which are incorporated herein by reference.

### BACKGROUND

The invention relates to a container feeding device, in particular a cup feeding device, for a feeding of containers, in particular cups, to a metering and/or filling device, with at least one magazine unit for receiving a plurality of containers, in particular a plurality of container stacks, and with at least one lift unit for a transport of the containers, in particular the container stacks, along a lifting direction of the lift unit, in particular to a plane that is situated higher than a transport surface of a transport element of the magazine unit.

Such container feeding devices are already known, wherein in the already known container feeding devices containers, in particular container stacks, are substantially guide-free at least in the transport direction during a transport from the magazine unit to the lift unit, because of which the containers, in particular the container stacks, may tilt or tip over during a transfer of the containers, in particular the container stacks, from the magazine unit to the lift unit. This may lead to a jamming of the containers, in particular the container stacks, in the lift unit and thus to an undesired machine stop that must be addressed by an operator.

### SUMMARY

The objective of the invention is in particular to provide a generic container feeding device, a generic production machine and a generic method with improved properties with regard to process reliability. The objective is achieved according to the invention.

The invention is based on a container feeding device, in particular a cup feeding device, for a feeding of containers, in particular cups, to a metering and/or filling device, with at least one magazine unit for receiving a plurality of containers, in particular a plurality of container stacks, and with at least one lift unit for a transport of the containers, in particular the container stacks, along a lifting direction of the lift unit, in particular to a plane that is situated higher than a transport surface of a transport element of the magazine unit.

It is proposed that the container feeding device comprises at least one movement unit that supports the lift unit such that it is movable, in particular drivably movable, relative to the magazine unit, in particular relative to a frame of the magazine unit, along a movement axis of the lift unit that runs transversal, in particular at least substantially perpendicular, to the lifting direction. The implementation according to the invention advantageously allows realizing a high level of process reliability. Advantageously, guiding of the containers, in particular the container stacks, is enabled during a transfer of the containers, in particular the container stacks, from the magazine unit to the lift unit. Advantageously, tipping over or tilting of the containers, in particular the container stacks, can be counteracted. It is advantageously achievable that the container, in particular the container stack, can be held at least substantially in a tilt-proof manner during a transfer of the containers, in particular the container stacks, from the magazine unit to the lift unit. Advantageously, an undesired machine stop due to a jamming of the container, in particular the container stack, can be counteracted in a structurally simple manner. Advantageously, a movement of the lift unit approaching the magazine unit and a movement of the lift unit away from the magazine unit can be realized in order to enable secure and guided transfer of the containers, in particular the container stacks, from the magazine unit to the lift unit.

The magazine unit preferably comprises a plurality of feeding tracks, which are in particular separated from one another by lateral guide elements of the magazine unit, for the purpose of receiving a plurality of containers, in particular a plurality of container stacks. Preferentially the magazine unit comprises at least two feeding tracks for receiving a plurality of containers, in particular a plurality of container stacks. Particularly preferentially the magazine unit comprises an integer multiple of two feeding tracks for receiving a plurality of containers, in particular a plurality of container stacks, such as for example four feeding tracks, six feeding tracks, eight feeding tracks, ten feeding tracks, twelve feeding tracks or the like. However, it is also conceivable that the magazine unit comprises an odd number of feeding tracks, such as for example three feeding tracks, five feeding tracks, seven feeding tracks, nine feeding tracks, eleven feeding tracks or the like. Preferentially a number of feeding tracks depends on a specific field of application or use of the container feeding device. Preferably, for each feeding track a plurality of containers, in particular a plurality of container stacks, is arrangeable in the respective feeding track, and is in particular arrangeable one behind the other as a row. The containers, in particular the container stacks, in a state when arranged in at least one feeding track, preferably form in the feeding track a row of containers, in particular a row of container stacks, along a transport direction of the magazine unit, in particular of a transport element of the magazine unit.

The feeding tracks of the magazine unit are preferably oriented at least substantially parallel to one another. “Substantially parallel” is here in particular to mean an orientation of a direction relative to a reference direction, in particular in a plane, wherein the direction has a deviation from the reference direction that is in particular smaller than 8°, advantageously smaller than 5° and particularly advantageously smaller than 2°. Preferentially the feeding tracks are arranged within the frame of the magazine unit. In a ready-to-operate state of the container feeding device, the feeding tracks are preferably arranged so as to be inclined relative to a horizontal plane and/or relative to a base surface of a frame unit of a production machine comprising the container feeding device. The base surface is configured to support weight forces and/or operating forces of the production machine on a ground, for example a production hall floor or the like.

The magazine unit preferably comprises at least one transport element, in particular at least one circulatingly drivable transport belt, for a transport of the container, in particular the container stack, along a transport direction. The transport element is preferentially configured to transport the container, in particular the container stack, in the feeding track along the transport direction, in particular into the lift unit. “Configured” is in particular to mean specifically implemented, specifically designed and/or specifically equipped. By an object being configured for a specific function is in particular to be understood that the object fulfils and/or carries out this specific function in at least one application state and/or operation state. The transport element preferably comprises a transport surface on which the container, in particular the container stack, is arranged in a state when arranged in the magazine unit, in particular a transport surface on which the container, in particular the container stack, stands. In a ready-to-operate state of the container feeding device, the transport surface is preferably arranged so as to be inclined relative to the horizontal plane and/or relative to the base surface of the frame unit of the production machine. The transport surface preferably includes an angle with the horizontal plane and/or with the plane extending at least substantially parallel to the base surface of the frame unit of the production machine, said angle being in particular smaller than 45°, preferably smaller than 35° and particularly preferably smaller than 25°. Very particularly preferably, the transport surface includes an angle with the horizontal plane and/or with the plane extending at least substantially parallel to the base surface of the frame unit of the production machine, said angle having a value from a value range of 0° to 20°. The magazine unit preferably comprises a plurality of transport elements, in particular a plurality of circulatingly drivable transport belts, for a transport of the containers, in particular container stacks, which are arranged in the magazine unit, along the transport direction. Preferentially each feeding track is assigned at least one transport element of the plurality of transport elements, in particular one individual transport element per feeding track. The transport elements preferably all have an identical implementation. A description of one of the transport elements preferably applies to all of the transport elements. Preferentially the transport elements, in particular all transport elements, of the magazine unit are realized as circulatingly drivable transport belts. However, it is also conceivable that for a transport of the containers, in particular the container stacks, along the transport direction, the transport elements have a different implementation deemed expedient by someone skilled in the art, like for example as a slide, as a fluid-dynamic transport element, as an electrodynamic transport element, or the like. The transport elements are preferably configured for a feeding of the containers, in particular container stacks, which are arranged in the feeding tracks, to the lift unit. The containers, in particular container stacks, arranged in the feeding tracks are preferably transportable in the feeding track along the transport direction, in particular as far as into the lift unit, by means of the transport element assigned to the respective feeding track.

The lift unit preferably comprises at least one lift element, in particular a lift finger, for a transport of the containers, in particular of a container stack, along the lifting direction. The lift element is preferably supported such that it is movable along the lifting direction, in particular supported such that it is drivably movable along the lifting direction. The lift element is preferably movable back and forth along and against the lifting direction. After a transport of the containers, in particular of a container stack, along the lifting direction, the lift element is preferably movable against the lifting direction into an initial position of the lift element, in which containers, in particular a container stack, can be transported onto the lift element by means of the transport element. The lift unit preferably comprises a plurality of lift elements. The lift elements of the lift unit preferably have identical implementation. A description of one of the lift elements preferably applies to all of the lift elements. The lift element is preferably assigned to a lifting track of the lift unit. The lift unit preferably comprises a plurality of lifting tracks, wherein each lifting track is assigned at least one of the lift elements of the lift unit. Preferentially each feeding track is assigned a lifting track of the lift unit. A number of lifting tracks of the lift unit preferably corresponds to a number of feeding tracks of the magazine unit. Movement paths of the lift elements in the lifting tracks preferably define a lift plane of the lift unit. The lifting direction preferably runs at least substantially parallel to the lift plane of the lift unit. The lift plane of the lift unit preferably extends at least substantially perpendicular to the transport surfaces of the transport elements.

The movement unit may be configured for a translational and/or rotational movable support of the lift unit relative to the magazine unit. It is conceivable that the lift unit is movably supported relative to the magazine unit by means of the movement unit in such a way that the lift unit is as a whole translationally movable along the movement axis of the lift unit relative to the magazine unit, that the lift unit is pivotable around the movement axis of the lift unit relative to the magazine unit, that the lift unit can be first pivoted around the movement axis relative to the magazine unit and can then be moved translationally along the movement axis of the lift unit relative to the magazine unit or vice versa, or that the lift unit is movable in a different manner, deemed expedient by someone skilled in the art, along and/or around the movement axis of the lift unit relative to the magazine unit. The movement unit preferably comprises at least one guide element, in particular at least one linear guide element, for guiding a movement of the lift unit relative to the magazine unit along and/or around the movement axis of the lift unit. The guide element may be realized as a slide bearing, as a roller bearing, as a fluid bearing or the like. In at least one implementation of the container feeding device, the guide element is preferably realized as a linear guide carriage. However, it is also conceivable that the guide element has a different implementation that is deemed expedient by someone skilled in the art, in particular a suitable implementation expedient for a type of movement that is to be guided. The movement unit preferably comprises four guide elements for guiding a movement of the lift unit relative to the magazine unit along and/or around the movement axis of the lift unit. Preferably respectively two guide elements are arranged on each of two outer sides of the lift unit. The guide elements preferably have identical implementation, in particular except for a side-inverted implementation. A description of one of the guide elements preferably applies to all of the guide elements.

Preferentially the movement axis of the lift unit runs at least substantially perpendicular to the lifting direction of the lift unit. The expression “substantially perpendicular” is here in particular to define an orientation of a direction relative to a reference direction, wherein the direction and the reference direction, in particular viewed in a projection plane, include an angle of 90° and the angle has a maximum deviation of in particular less than 8°, advantageously less than 5° and particularly advantageously less than 2°. The movement axis of the lift unit is preferably realized as a linear movement axis along which the lift unit is supported so as to be movable translationally relative to the magazine unit. Alternatively or additionally it is however also conceivable that the movement axis is realized as a rotational movement axis, wherein the lift unit is supported so as to be rotationally movable around the rotational movement axis relative to the magazine unit. The movement axis preferably runs at least substantially parallel to the transport surface of the transport element. Preferentially the movement axis runs at least substantially perpendicular to the lift plane of the lift unit.

Furthermore, it is proposed that the movement axis of the lift unit, along which the lift unit is supported so as to be movable, in particular drivably movable, relative to the magazine unit, is oriented with an inclination relative to a horizontal plane, in particular the above-mentioned horizontal plane, and in particular includes an angle with the horizontal plane that has a value from a value range between 0° and 90°. The movement axis of the lift unit preferably includes with the horizontal plane and/or with the plane extending at least substantially parallel to the base surface of the frame unit of the production machine an angle which is in particular smaller than 45°, preferably smaller than 35° and particularly preferably smaller than 25°. Very particularly preferably, the movement axis of the lift unit includes with the horizontal plane and/or with the plane extending at least substantially parallel to the base surface of the frame unit of the production machine an angle which has a value from a value range of 0° to 20°. Preferably, due to an inclined arrangement of the magazine unit together with the lift unit, on a side of the transport element facing away from the lift unit a distance of the transport surface of the transport element relative to the base surface of the frame unit of the production machine is greater than a distance of the transport surface of the transport element relative to the base surface of the frame unit of the production machine on a side of the transport element facing towards the lift unit. The implementation according to the invention allows using, in a structurally simple manner, a gravitational force for supporting a movement of the lift unit in at least one direction along the movement axis. Advantageously, it is possible to counteract a tipping over of the containers, in particular the container stacks, during a loading of the magazine unit, in particular of the feeding tracks, towards an operator. Advantageously, a high level of process reliability can be realized. Advantageously, guiding of the containers, in particular the container stacks, is enabled during a transfer of the containers, in particular the container stacks, from the magazine unit to the lift unit. It is advantageously achievable that the container, in particular the container stack, can be held at least substantially in a tilt-proof manner during a transfer of the containers, in particular the container stacks, from the magazine unit to the lift unit. Advantageously, an undesired machine stop due to a jamming of the container, in particular the container stack, can be counteracted in a structurally simple manner.

It is moreover proposed that the movement unit comprises at least one drive, in particular at least one servo cylinder, by means of which the lift unit is actively movable along the movement axis of the lift unit relative to the magazine unit. The drive is preferably realized as a linear drive, in particular as a servo cylinder. However, it is also conceivable that the drive has a different implementation deemed expedient by someone skilled in the art, like for example as a rack-and-pinion drive, as a hydraulic cylinder, as a pneumatic cylinder, or the like. Preferentially the drive comprises a drive axis that runs at least substantially parallel to the movement axis of the lift unit. The drive is preferably arranged with one end at the frame of the magazine unit, in particular fixed thereto, and with a further end the drive is arranged at the lift unit, in particular fixed thereto. The movement unit preferably comprises at least two drives for an active movement of the lift unit relative to the magazine unit. The drives preferably have identical implementation, in particular an implementation as a servo cylinder. Preferably, respectively one drive is arranged on each of the two outer sides of the lift unit. However, it is also conceivable that the movement unit comprises only a single drive for an active movement of the lift unit relative to the magazine unit. The container feeding device and/or the production machine preferably comprise(s) at least one control or regulation unit that is configured for a controlling or regulation of the drive(s) of the movement unit for a movement of the lift unit. A “control or regulation unit” is in particular to mean a unit with at least one control electronics unit. A “control electronics unit” is in particular to mean a unit with a processor unit and with a memory unit as well as with an operating program stored in the memory unit. The container feeding device and/or the production machine comprise(s) at least one sensor unit, the signals of which can be processed by the control or regulation unit at least for a controlling or regulation of a movement of the lift unit. The control or regulation unit is preferably configured, in a manner already known to someone skilled in the art, for a controlling or regulation of further functions of the container feeding device and/or of the production machine, like for example a drive of the transport elements of the magazine unit, a movement of stopper elements, in particular separating flaps, of the magazine unit, or the like. A high degree of automatization is advantageously achievable by the implementation according to the invention. A precise controlling or regulation of a movement of the lift unit can be realized. Advantageously, a high level of process reliability can be realized. Advantageously, a secure transfer of the containers, in particular the container stacks, from the magazine unit to the lift unit is achievable.

Moreover, it is proposed that the lift unit comprises at least one movably supported lateral guide element, which is configured to at least partially encompass or cover the containers, in particular the container stacks, in a state when they are arranged in the lift unit. The lateral guide element is preferably realized as a lateral guide plate. However, it is also conceivable that the lateral guide element has a different implementation deemed expedient by someone skilled in the art, like for example an implementation as a lateral guide grid, as a lateral guide web, or the like. Viewed along a direction that runs at least substantially parallel to the lift plane and at least substantially parallel to a plane comprising the movement axis of the lift unit, the lateral guide element preferably extends at least for the most part over a maximum extent of the lifting track. The lateral guide element preferably extends along the lifting track at least by more than 50% of the maximum extent of the lifting track. It is conceivable that the lateral guide element is composed of several individual segments, which are arranged along the lifting track and are spaced apart from one another, wherein their sum of maximum individual extents corresponds to at least more than 50% of the maximum extent of the lifting track. It is also conceivable that the lateral guide element is a continuous element which is arranged along the lifting track and the maximum extent of which corresponds to at least more than 50% of the maximum extent of the lifting track. Further implementations of the lateral guide element, deemed expedient by someone skilled in the art, are also conceivable. In a state when the containers, in particular the container stacks, are arranged in the lift unit, the lateral guide element preferably projects beyond the containers, in particular the container stacks, along a direction that runs at least substantially perpendicular to the lift plane. The lateral guide element may be supported such that it is movable translationally and/or rotationally. The lateral guide element may be supported so as to be actively movable, in particular by means of a motor of the lift unit, or may be supported so as to be manually movable, in particular for a change or adjustment of a position of the lateral guide element relative to the container, in particular relative to the container stack. The lift unit preferably comprises two lateral guide elements per lifting track, in particular one lefthand lateral guide element and one righthand lateral guide element per lifting track. The implementation according to the invention advantageously allows realizing a guiding of the containers, in particular the container stacks, during a transport by the lift unit. Advantageously, secure accommodation of the containers, in particular the container stacks, in the lift unit can be realized. Advantageously, a high level of process reliability can be realized.

It is also proposed that the lift unit comprises at least one, in particular the afore-mentioned, movably supported lateral guide element, a movement axis of which extends transversal, in particular at least substantially perpendicular, to the movement axis of the lift unit. Preferentially the movement axis of the lateral guide element extends at least substantially parallel to the transport surface of the transport element. The movement axis of the lateral guide element in particular extends at least substantially parallel to the lift plane of the lift unit. Preferentially the movement axis of the lateral guide element extends at least substantially perpendicular to the movement axis of the lift unit. Preferentially the two lateral guide elements are supported movably in opposed directions along the movement axes of the lateral guide elements, in particular for a change or an adjustment of a position of the lateral guide elements relative to the cup, in particular relative to the cup stack. The implementation according to the invention advantageously allows realizing a partial clamping of the containers, in particular the container stacks, in a state when the containers, in particular the container stacks, are arranged in the lift unit, in particular in the lifting track. Advantageously, a guiding of the containers, in particular the container stacks, can be realized during a transport by the lift unit. Advantageously, secure accommodation of the containers, in particular the container stacks, in the lift unit can be realized. Advantageously, a high level of process reliability can be realized.

Furthermore, a production machine with at least one container feeding device according to the invention is proposed. The production machine may comprise further devices and/or units, deemed expedient by someone skilled in the art, which can be used for a handling, for a filling and/or for a production of products, in particular of food products. The production machine is preferably configured for a production, filling, packaging and/or secondary packaging of food products. The production machine may comprise, in addition to the container feeding device, a plurality of further devices and/or units, deemed expedient by someone skilled in the art, like for example a forming device for packagings, a cutting device, a filling device, a sterilization device, a closure device, a secondary-packaging device, a metering device, or the like. Preferentially the production machine comprises at least one frame unit, in particular the afore-mentioned frame unit, and at least one bearing unit, in particular a linear pull-out unit, wherein the bearing unit is configured to movably support the container feeding device as a whole relative to the frame unit. The magazine unit, the lift unit and the movement unit are preferably supported by means of the bearing unit in such a way that they are movable together, in particular for maintenance purposes or the like. The bearing unit may comprise a motor capable of driving the container feeding device such that it is movable as a whole relative to the frame unit, or the container feeding device is manually movable as a whole relative to the frame unit. A movement axis of the bearing unit, along which the container feeding device is supported so as to be movable as a whole relative to the frame unit, preferably runs at least substantially parallel to the horizontal plane and/or to the base surface of the frame unit. The implementation according to the invention advantageously allows achieving a high level of process reliability during a production, filling, packaging and/or secondary packaging of products, in particular food products, by means of the production device.

Beyond this, the invention is based on a method for feeding containers, in particular cups, to a metering and/or filling device, in particular of the production machine, by means of a container-feeding device, in particular by means of a container-feeding device according to the invention. It is proposed that a lift unit of the container feeding device is moved by means of a movement unit relative to a magazine unit of the container feeding device along a movement axis of the lift unit that runs transversal, in particular at least substantially perpendicular, to a lifting direction of the lift unit. The implementation according to the invention advantageously allows realizing a high level of process reliability. Advantageously, guiding of the containers, in particular the container stacks, is enabled during a transfer of the containers, in particular the container stacks, from the magazine unit to the lift unit. Advantageously, tipping over or tilting of the containers, in particular the container stacks, can be counteracted. It is advantageously achievable that the container, in particular the container stack, can be held at least substantially in a tilt-proof manner during a transfer of the containers, in particular the container stacks, from the magazine unit to the lift unit. Advantageously, an undesired machine stop due to a jamming of the container, in particular the container stack, can be counteracted in a structurally simple manner. Advantageously, a movement of the lift unit to the magazine unit and a movement of the lift unit away from the magazine unit can be realized in order to enable secure and guided transfer of the containers, in particular the container stacks, from the magazine unit to the lift unit.

In addition, it is proposed that the lift unit is actively moved by means of at least one drive, in particular the afore-mentioned drive, of the movement unit up to a proximity region of a movably supported stopper element, in particular the afore-mentioned movably supported stopper element, in particular a movably supported separating flap, of the magazine unit, and/or up to a proximity region of a transport element, in particular the afore-mentioned transport element, of the magazine unit. A “proximity region” is in particular to mean a region having, in particular viewed along the transport direction of the magazine unit, a maximum distance of in particular less than 100 mm, preferably less than 50 mm, preferentially less than 20 mm and very particularly preferentially less than 10 mm, relative to the transport element, in particular relative to a deflection edge of the transport element, and/or relative to the stopper element. The implementation according to the invention advantageously allows realizing secure transfer of the containers, in particular the container stacks, from the magazine unit to the lift unit. It is advantageously achievable that the container, in particular the container stack, can be held at least substantially in a tilt-proof manner during a transfer of the containers, in particular the container stacks, from the magazine unit to the lift unit.

It is further proposed that at least one, in particular the afore-mentioned, lateral guide element of the lift unit, which is configured to at least partially encompass or cover the containers, in particular the container stacks, in a state when they are arranged in the lift unit, is moved actively. The lateral guide element and the further lateral guide element are preferably moved actively. Preferentially, for a transport of the containers, in particular the container stacks, all lefthand lateral guide elements and all righthand lateral guide elements are moved actively, in particular jointly moved actively, by means of the lift unit, wherein all lefthand lateral guide elements are moved in one direction and all righthand lateral guide elements are moved in a direction that is opposed thereto. The implementation according to the invention allows realizing, in a structurally simple manner, an adjustment of a distance of the lateral guide element relative to the further lateral guide element for an adaption of the lift unit to a container format, in particular a cup format.

Furthermore, it is proposed that at least one, in particular the afore-mentioned, lefthand lateral guide element of the lift unit, and a further, in particular the afore-mentioned, righthand lateral guide element of the lift unit, are moved actively in opposed directions. Preferentially, for a transport of the containers, in particular the container stacks, the lateral guide element and the further lateral guide element are moved towards one another with the lift unit and are then moved away from one another again. The implementation according to the invention advantageously allows realizing secure guiding of the containers, in particular the container stacks, during a transport by means of the lift unit. An adjustment of a distance of the lateral guide element relative to the further lateral guide element for an adaption of the lift unit to a container format, in particular a cup format, can be realized in a structurally simple manner. The container feeding device according to the invention, the production machine according to the invention and/or the method according to the invention shall not be limited to the above-described application and implementation. In particular, in order to fulfil a functionality that is described here, the container feeding device according to the invention, the production machine according to the invention and/or the method according to the invention may comprise a number of individual elements, components and units as well as method steps that differs from a number given here. In addition, in the value ranges indicated in this disclosure, values situated within the mentioned limits shall also be considered as being disclosed and as being usable as desired.

### BRIEF DESCRIPTION OF THE DRAWINGS

Further advantages will be apparent from the following description of the drawings. An exemplary embodiment of the invention is shown in the drawings. The drawings, the description and the claims contain a plurality of features in combination. Someone skilled in the art will purposefully also consider the features individually and will find further expedient combinations.

In the drawings:

FIG. 1 shows a production machine according to the invention with at least one container feeding device according to the invention, in a schematic representation,

FIG. 2 shows a detailed view of the container feeding device according to the invention in an operational position in a frame unit of the production machine according to the invention, in a schematic representation,

FIG. 3 shows a detailed view of the container feeding device according to the invention in a maintenance position in the frame unit of the production machine according to the invention, in a schematic representation,

FIG. 4 shows a plan view of the container feeding device according to the invention in a schematic representation,

FIG. 5 shows a detailed view of a magazine unit and a lift unit of the container feeding device according to the invention, wherein the lift unit is in a state when moved away from the magazine unit, in a schematic representation,

FIG. 6 shows a detailed view of the magazine unit and the lift unit of the container feeding device according to the invention, wherein the lift unit is in a state when moved to the magazine unit, in a schematic representation,

FIG. 7 shows a detailed view of the lift unit of the container feeding device according to the invention, in a schematic representation, and

FIG. 8 shows a schematic process flow of a method according to the invention, in a schematic representation.

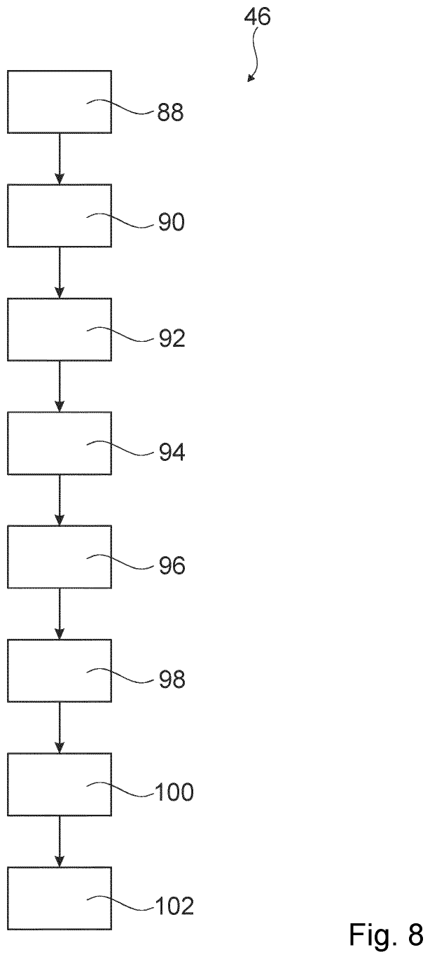

### DETAILED DESCRIPTION

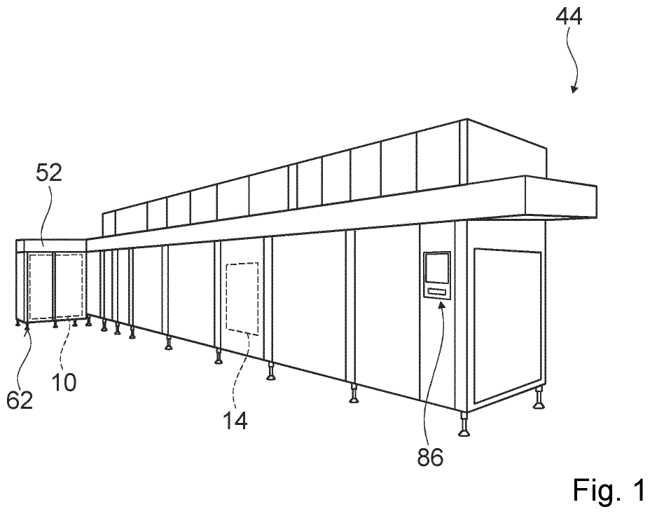

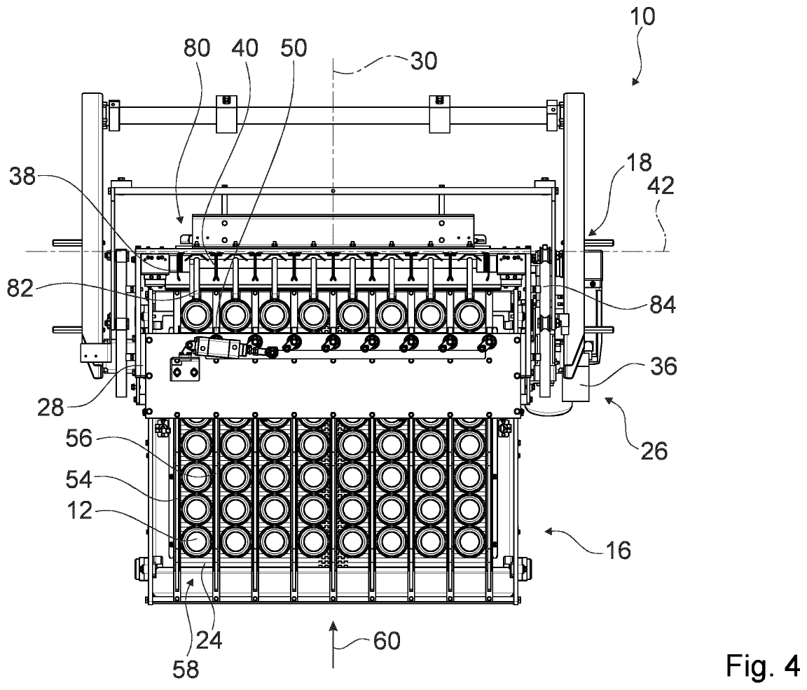

FIG. 1 shows a production machine 44 with at least one container feeding device 10 for a feeding of containers 12 (cf. FIGS. 4 to 7), in particular cups, to a metering and/or filling device 14 of the production machine 44. Preferably, for a feeding of containers 12 into which products, in particular food products, can be filled, the container feeding device 10 is connected to the metering and/or filling device 14 via a transport device (not shown here in detail) of the production machine 44 in a manner already known to a person skilled in the art. The production machine 44 is preferably configured for a production, filling, packaging and/or secondary packaging of food products. Preferably, the production machine 44 is configured at least for a filling of food products into containers 12. The production machine 44 may be realized, for example, as a food packaging machine, as a food filling machine, as a food production machine, as a combination of the afore-mentioned machines or the like. The production machine 44 may comprise further devices and/or units, deemed expedient by someone skilled in the art, which are used for a production and/or processing of products, in particular food products, like for example a further transport device, a sterilization device, a closure device, a secondary-packaging device, or the like.

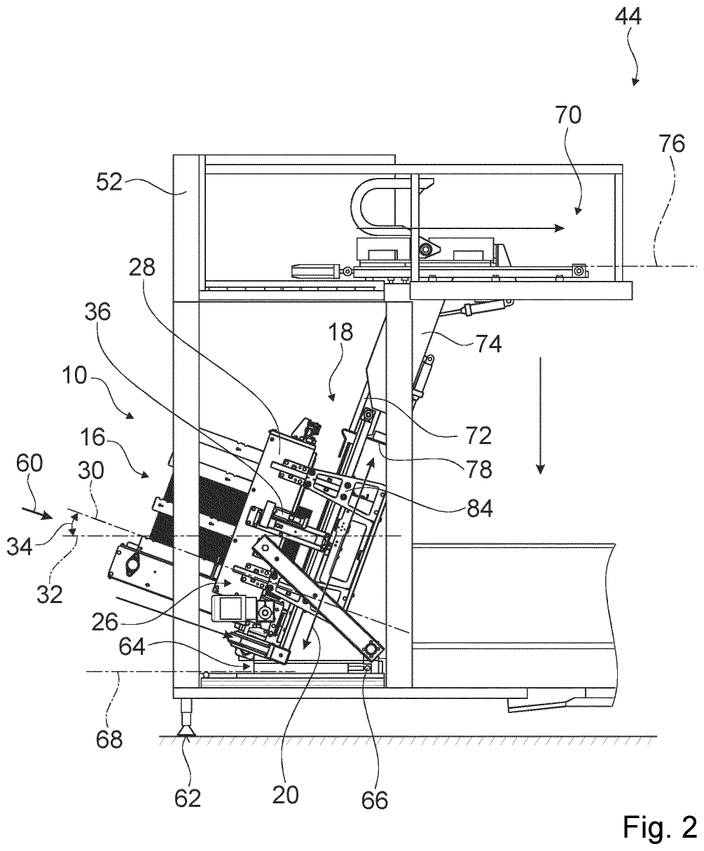

FIG. 2 shows the container feeding device 10 in an operational position in a frame unit 52 of the production machine 44. The container feeding device 10 is configured for a feeding of containers 12, in particular cups, to the metering and/or filling device 14, in particular via the transport device of the production machine 44. The container feeding device 10 is preferably realized as a cup feeding device. The container feeding device 10 comprises at least one magazine unit 16 for receiving a plurality of containers 12 (see also FIG. 4), in particular a plurality of container stacks (see also FIG. 4). The container feeding device 10 further comprises at least one lift unit 18 for a transport of the containers 12, in particular the container stacks, along a lifting direction 20 of the lift unit 18, in particular to a plane that is situated higher than a transport surface 22 of a transport element 24 of the magazine unit 16.

In the operational position, the lift unit 18 is configured to interact with a container pick-up unit 70 of the production machine 44. The container pick-up unit 70 is preferably arranged above the lift unit 18. The container pick-up unit 70 preferably comprises a container accommodation basket 72 into which the lift unit 18 transports the containers 12, in particular the container stacks, along the lifting direction 20. The container accommodation basket 72 is arranged on a receiving frame 74 of the container pick-up unit 70 in such a way that it is detachable, in particular without tools. Preferably the container accommodation basket 72 is exchangeable, preferably without tools, depending on a container format of the containers 12, in particular container stacks, that are to be accommodated. The container accommodation basket 72 preferably has connection recesses (not shown here in detail), in particular in the form of a keyhole. The connection recesses comprise a region having a small width and a directly adjoining region having a large width. The receiving frame 74 preferably comprises hook-in bolts (not shown here in detail) configured to interact with the connection recesses. The receiving frame 74 is supported on the frame unit 52 in such a way that it is pivotably movable. A pivot axis of the receiving frame 74 preferably runs at least substantially parallel to a horizontal plane 32 and/or at least substantially parallel to a base surface 62 of the frame unit 52. The pivot axis of the receiving frame 74 preferably runs at least substantially perpendicular to the lifting direction 20 of the lift unit 18, in particular at least substantially parallel to a lift plane of the lift unit 18. A linear movement axis of the receiving frame 74 preferably runs at least substantially parallel to the horizontal plane 32 and/or at least substantially parallel to the base surface 62 of the frame unit 52. The linear movement axis of the receiving frame 74 preferably runs transversal to the lifting direction 20 of the lift unit 18, in particular transversal to the lift plane of the lift unit 18.

Preferentially the receiving frame 74 is supported such that it is translationally movable along a linear axis 76 of the container pick-up unit 70. The container pick-up unit 70 further comprises closure elements 78 configured to close the container accommodation basket 72, on a side facing towards the lift unit 18, after containers 12, in particular container stacks, have been filled in. The closure elements 78 are preferably supported such that they are, in particular drivably, movable. The closure elements 78 are preferably realized in a fork shape, in particular in order to enable lifting elements 82 of the lift unit 18 being passed through. The container accommodation basket 72 preferably comprises a plurality of separate receiving spaces (not shown here in detail) for receiving the containers 12, in particular the container stacks, wherein a number of receiving spaces corresponds to a number of lifting tracks 80 of the lift unit 18 and/or to a number of feeding tracks 58 of the magazine unit 16.

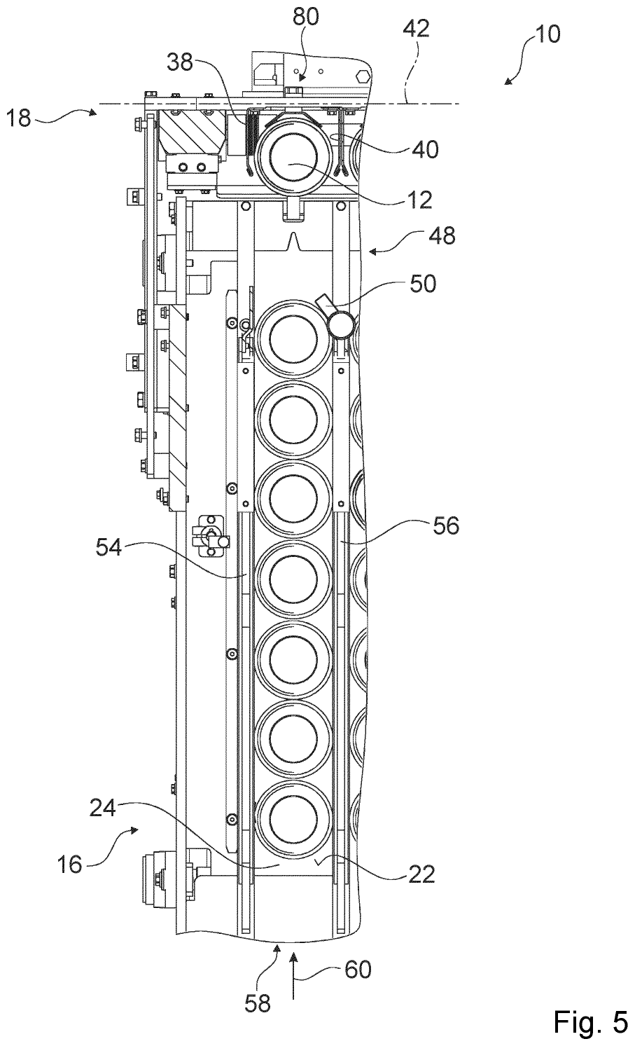

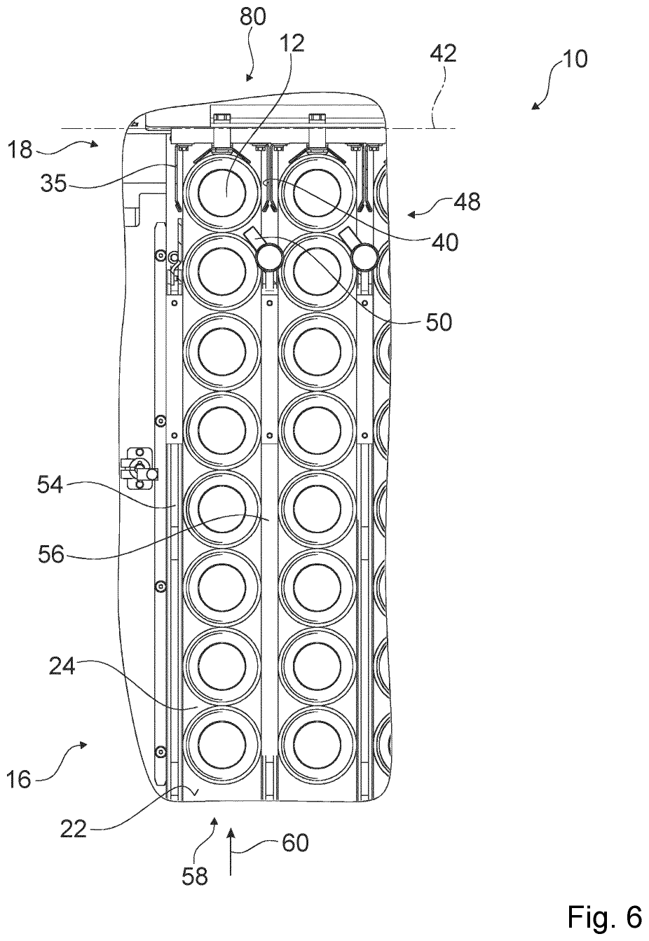

The magazine unit 16 preferably comprises a plurality of feeding tracks 58, which are in particular separated from one another by lateral guide elements 54, 56 of the magazine unit 16, for receiving a plurality of containers 12, in particular a plurality of container stacks (see also FIG. 4). The magazine unit 16 preferably comprises at least two feeding tracks 58 for receiving a plurality of containers 12, in particular a plurality of container stacks (see also FIG. 4). The feeding tracks 58 of the magazine unit 16 are preferably oriented at least substantially parallel to one another. Preferentially the feeding tracks 58 are arranged within a frame 28 of the magazine unit 16. In a ready-to-operate state of the container feeding device 10, the feeding tracks 58 are preferably arranged with an inclination relative to the horizontal plane 32 and/or relative to the base surface 62 of the frame unit 52 of the production machine 44. The base surface 62 is configured to support weight forces and/or operating forces of the production machine 44 on a ground (not shown here in detail), for example a production hall floor or the like. Preferably, for each feeding track 58 a plurality of containers 12, in particular a plurality of container stacks, are arrangeable in the respective feeding track 58, and are in particular arrangeable one behind the other as a row (see also FIG. 4). The containers 12, in particular the container stacks, in a state when arranged in at least one feeding track 58, preferably form in the feeding track 58 a row of containers 12, in particular container stacks, along a transport direction 60 of the magazine unit 16, in particular of the transport element 24 of the magazine unit 16 (see also FIG. 4). The magazine unit 16 preferably comprises, in particular per each feeding track 58, at least one movably supported stopper element 50 (see FIGS. 5 and 6), in particular a movably supported separating flap. The stopper element 50 is preferably configured to singulate the containers 12, in particular container stacks, which are lined up in the feeding tracks 58 and/or to retain the lined-up containers 12, in particular container stacks, during a lifting operation by means of the lift unit 18.

The magazine unit 16 preferably comprises at least the transport element 24 for a transport of the container 12, in particular the container stack, along the transport direction 60 of the magazine unit 16. The transport element 24 is preferably realized as a circulatingly drivable transport belt. However, it is also conceivable that the transport element 24 has a different implementation deemed expedient by someone skilled in the art, like for example an implementation as a circulating transport chain, as a transport slide, or the like. The transport element 24 is preferentially configured to transport the container 12, in particular the container stack, in the feeding track 58 along the transport direction 60, in particular into the lift unit 18. The transport element 24 preferably comprises the transport surface 22 on which the container 12, in particular the container stack, or the plurality of containers 12, in particular container stacks, are arranged in a state when arranged in the magazine unit 16, in particular the transport surface 22 which the container 12, in particular the container stack, stands on. In a ready-to-operate state of the container feeding device 10, the transport surface 22 is preferably arranged so as to be inclined relative to the horizontal plane 32 and/or relative to the base surface 62 of the frame unit 52 of the production machine 44. The magazine unit 16 preferably comprises a plurality of transport elements 24, in particular a plurality of circulatingly drivable transport belts, for a transport of the containers 12, in particular container stacks, which are arranged in the magazine unit 16, along the transport direction 60 (see also FIG. 4). Preferentially each feeding track 58 is assigned at least one transport element 24 of the plurality of transport elements 24, in particular one individual transport element 24 per feeding track 58. The transport elements 24 preferably all have identical implementation. A description of one of the transport elements 24 preferably applies to all of the transport elements 24. The transport elements 24 are preferably configured for a feeding of the containers 12, in particular container stacks, which are arranged in the feeding tracks 58, to the lift unit 18 (see also FIG. 4). The containers 12, in particular container stacks, which are arranged in the feeding tracks 58, are preferably transportable in the feeding track 58 along the transport direction 60, in particular into the lift unit 18, by means of the transport element 24 that is assigned to the respective feeding track 58.

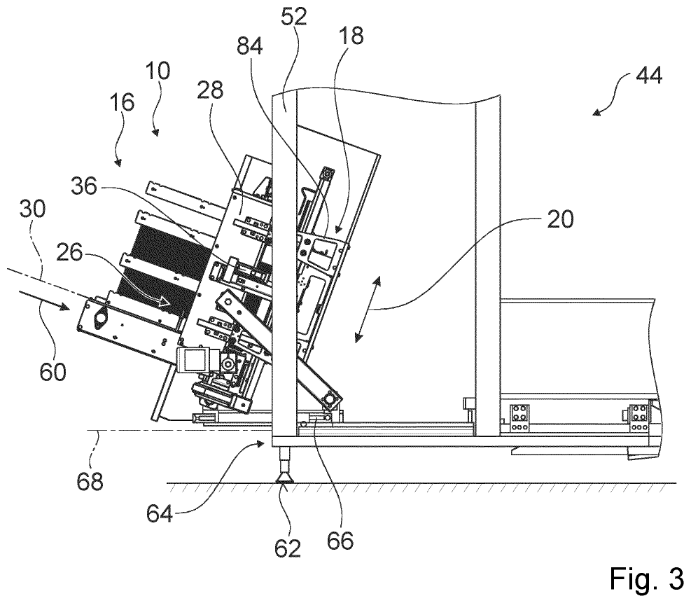

FIG. 3 shows the container feeding device 10 in a maintenance position in the frame unit 52 of the production machine 44. The production machine 44 preferably comprises at least one bearing unit 64, in particular a linear pull-out unit. The bearing unit 64 is preferably configured to movably support the container feeding device 10 as a whole relative to the frame unit 52. The magazine unit 16, the lift unit 18 and a movement unit 26 of the container feeding device 10 are preferably supported by means of the bearing unit 64 in such a way that they are movable together, in particular for maintenance purposes or the like. The bearing unit 64 may comprise a motor 66 capable of moving the container feeding device 10 as a whole, in a drivable manner, relative to the frame unit 52. The motor 66 is preferably configured to cooperate with a toothed rack (not shown here in detail) of the bearing unit 64 in order to move the container feeding device 10 as a whole relative to the frame unit 52. The toothed rack is preferably arranged on a linear guide of the bearing unit 64. The motor 66 may be realized as an electromotor, as a linear motor, as a compressed-air motor, as a hydraulic motor, or as another motor deemed expedient by someone skilled in the art. It is further conceivable that the motor 66 cooperates with another element of the bearing unit 64, deemed expedient by someone skilled in the art, in order to move the container feeding device 10 as a whole relative to the frame unit 52. Alternatively or additionally, it is conceivable that the container feeding device 10 as a whole is manually movable relative to the frame unit 52 by an operator. It is conceivable that the bearing unit 64 is realized free of the motor 66 and of the toothed rack, in particular if there is manual movability of the container feeding device 10 as a whole relative to the frame unit 52. A movement axis 68 of the bearing unit 64, along which the container feeding device 10 is supported so as to be movable as a whole relative to the frame unit 52, preferably runs at least substantially parallel to the horizontal plane 32 and/or to the base surface 62 of the frame unit 52.

The container feeding device 10 comprises at least one movement unit 26, which supports the lift unit 18 such that it is movable, in particular drivably movable, relative to the magazine unit 16, in particular relative to the frame 28 of the magazine unit 16, along a movement axis 30 of the lift unit 18 that runs transversal, in particular at least substantially perpendicular, to the lifting direction 20. The lift unit 18 preferably comprises at least the lift element 82, in particular a lift finger, for a transport of the containers 12, in particular of a container stack, along the lifting direction 20 (see also FIG. 4). The lift element 82 is preferably supported such that it is movable along the lifting direction 20, in particular supported such that it is drivably movable along the lifting direction 20. The lift element 82 is preferably movable back and forth along and against the lifting direction 20. Preferably, after a transport of the containers 12, in particular of an individual container stack, along the lifting direction 20, the lift element 82 is movable against the lifting direction 20 into an initial position of the lift element 82, in which containers 12, in particular an individual container stack, can be transported onto the lift element 82 by means of the transport element 24. The lift unit 18 preferably comprises a plurality of lift elements 82. The lift elements 82 of the lift unit 18 preferably have identical implementation. A description of one of the lift elements 82 preferably applies to all of the lift elements 82. The lift element 82 is preferably assigned to an individual lifting track 80 of the lift unit 18. The lift unit 18 preferably comprises a plurality of lifting tracks 80, wherein each lifting track 80 is assigned at least one of the lift elements 82 of the lift unit 18. Preferentially each feeding track 58 is assigned a lifting track 80 of the lift unit 18. A number of lifting tracks 80 of the lift unit 18 preferably corresponds to a number of feeding tracks 58 of the magazine unit 16.

The movement unit 26 may be configured for a translational and/or a rotational movable support of the lift unit 18 relative to the magazine unit 16. The movement unit 26 preferably comprises at least one guide element 84, in particular at least one linear guide element, for guiding a movement of the lift unit 18 relative to the magazine unit 16 along and/or around the movement axis 30 of the lift unit 18. The guide element 84 may be realized as a slide bearing, as a roller bearing, as a fluid bearing or the like. In at least one implementation of the container feeding device 10, the guide element 84 is preferably realized as a linear guiding carriage. However, it is also conceivable that the guide element 84 has a different implementation deemed expedient by someone skilled in the art, in particular a suitable implementation expedient for a type of movement that is to be guided. The movement unit 26 preferably comprises four guide elements 84 for guiding a movement of the lift unit 18 relative to the magazine unit 16 along and/or around the movement axis 30 of the lift unit 18. Preferentially the movement axis 30 of the lift unit 18 extends at least substantially perpendicular to the lifting direction 20 of the lift unit 18. The movement axis 30 of the lift unit 18 is preferably realized as a linear movement axis along which the lift unit 18 is supported so as to be movable translationally relative to the magazine unit 16. Alternatively or additionally, it is however also conceivable that the movement axis 30 is realized as a rotational movement axis around which the lift unit 18 is supported so as to be movable rotationally relative to the magazine unit 16. The movement axis 30 preferably runs at least substantially parallel to the transport surface 22 of the transport element 24. Preferentially the movement axis 30 extends at least substantially perpendicular to the lifting plane of the lift unit 18.

The movement axis 30 of the lift unit 18, along which the lift unit 18 is supported so as to be, in particular drivably, movable relative to the magazine unit 16, is oriented so as to be inclined relative to the horizontal plane 32. In particular, the movement axis 30 of the lift unit 18 includes with the horizontal plane 32 an angle 34 which has a value from a value range between 0° and 90°. The movement axis 30 of the lift unit 18 preferably includes with the horizontal plane 32 and/or with the plane extending at least substantially parallel to the base surface 62 of the frame unit 52 an angle 34, which is in particular smaller than 45°, preferably smaller than 35° and particularly preferably smaller than 25°. Very particularly preferably, the movement axis 30 of the lift unit 18 includes with the horizontal plane 32 and/or with the plane extending at least substantially parallel to the base surface 62 of the frame unit 52 an angle 34 which has a value from a value range of 0° to 20°.

The movement unit 26 comprises at least one drive 36 by means of which the lift unit 18 is actively movable along the movement axis 30 of the lift unit 18 relative to the magazine unit 16. The drive 36 is preferably realized as a linear drive, in particular as a servo cylinder. However, it is also conceivable that the drive 36 has a different implementation deemed expedient by someone skilled in the art, like for example as a rack-and-pinion drive, as a hydraulic cylinder, as a pneumatic cylinder, or the like. Preferentially the drive 36 has a drive axis that runs at least substantially parallel to the movement axis 30 of the lift unit 18. The drive 36 is preferably arranged with one end at the frame 28 of the magazine unit 16, in particular fixed thereto, and with a further end the drive 36 is arranged at the lift unit 18, in particular fixed thereto. The container feeding device 10 and/or the production machine 44 preferably comprise(s) at least one control or regulation unit 86 (see FIG. 1), which is configured for a controlling or regulation at least of the drive 36 of the movement unit 26 for a movement of the lift unit 18. The container feeding device 10 and/or the production machine 44 comprise(s) at least one sensor unit (not shown here in detail) for a detection of positions of the individual elements and/or units of the container feeding device 10 and/or of the production machine 44, the signals of which can be processed by the control or regulation unit 86 at least for a controlling or regulation of a movement of the lift unit 18.

The lift unit 18 comprises at least one movably supported lateral guide element 38, 40, which is configured to at least partially encompass or cover the containers 12, in particular the container stacks, in a state when they are arranged in the lift unit 18 (see FIGS. 4 to 7). The lateral guide element 38, 40 is preferably realized as a lateral guide plate. However, it is also conceivable that the lateral guide element 38, 40 has a different implementation deemed expedient by someone skilled in the art, like for example an implementation as a lateral guide grid, as a lateral guide web, or the like. Preferably, in a state when the containers 12, in particular the container stacks, are arranged in the lift unit 18, the lateral guide element 38, 40 protrudes beyond the containers 12, in particular the container stacks, along a direction that runs at least substantially perpendicular to the lift plane. The lateral guide element 38, 40 may be supported such that it is movable translationally and/or rotationally. A movement axis 42 of the lateral guide element 38, 40 of the lift unit 18 preferably runs transversal, in particular at least substantially perpendicular, to the movement axis 30 of the lift unit 18. The lateral guide element 38, 40 may be actively supported such that it is actively movable, in particular by means of a motor or several motors (not shown here in detail), like for example by means of a hydraulic cylinder, by means of a pneumatic cylinder, by means of a servo cylinder or the like, of the lift unit 18, or the lateral guide element 38, 40 may be supported so as to be movable manually, in particular for a change or adjustment of a position of the lateral guide element 38, 40 relative to the container 12, in particular relative to the container stack. Preferably, the lift unit 18 comprises two lateral guide elements 38, 40 per lifting track 80, in particular one lefthand lateral guide element 38 and one righthand lateral guide element 40 per lifting track 80.

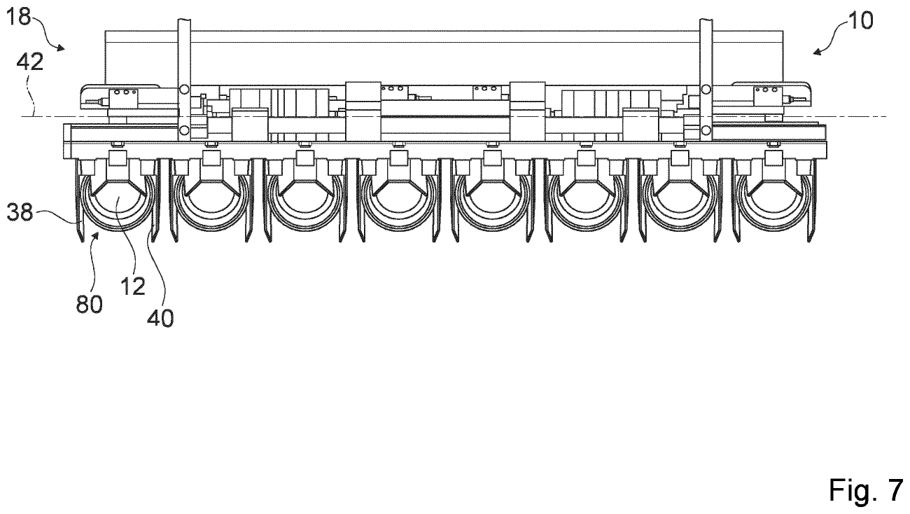

FIG. 7 shows a schematic process flow of a method 46 for feeding containers 12, in particular cups, to a metering and/or filling device 14, in particular the afore-mentioned metering and/or filling device 14, by means of a container-feeding device, in particular the afore-mentioned container feeding device 10. Preferably, in at least one method step 88 of the method 46, the magazine unit 16 is loaded with containers 12, in particular container stacks, in particular manually by an operator or automatically by a robot or the like. During a loading, the containers 12, in particular container stacks, are preferably inserted into the feeding tracks 58 of the magazine unit 16. Preferably the stopper elements 50 of the magazine unit 16 are closed during a loading. Due to an inclination of the magazine unit 16, the containers 12, in particular container stacks, preferably slide on the transport surfaces 22 of the transport elements 24 until the containers 12, in particular the container stacks, rest against the stopper elements 50 or against containers 12, in particular container stacks, which were laid in previously.

In at least one method step 90 of the method 46, the lift unit 18 is preferably moved relative to the magazine unit 16, in particular moved towards the magazine unit 16, by means of the movement unit 26 along the movement axis 30 of the lift unit 18 that runs transversal, in particular at least substantially perpendicular, to the lifting direction 20 of the lift unit 18. Preferentially, in particular in the method step 90, the lift unit 18 is actively moved, in particular traversed, by means of the drive 36 of the movement unit 26, up to a proximity region 48 of the movably supported stopper element 50, in particular stopper elements 50, of the magazine unit 16, and/or up to a proximity region 48 of the transport element 24, in particular of the transport elements 24, of the magazine unit 16.

In at least one method step 92 of the method 46, the stopper element 50, in particular the stopper elements 50, is/are preferably moved into an open position. In at least one method step 94 of the method 46, the containers 12, in particular one individual container stack per each feeding track 58, are preferably transported into the lift unit 18, in particular into the lifting track 80, in particular the lifting track 80 assigned to the respective feeding track 58, by means of the transport element 24. In at least one method step 96 of the method 46, preferably the stopper element 50, in particular the stopper elements 50, is/are moved into a closed position. In at least one method step 98 of the method 46, preferably at least one lateral guide element 38, 40 of the lift unit 18, which is configured to at least partially encompass the containers 12, in particular the container stacks, in a state when they are arranged in the lift unit 18, is moved actively. Preferentially, in the method step 98 of the method 46 at least the lateral guide element 38 of the lift unit 18 and a further lateral guide element 40 of the lift unit 18 are actively moved in opposed directions.

In at least one method step 100 of the method 46, preferentially the lift unit 18 is preferably moved relative to the magazine unit 16, in particular moved away from the magazine unit 16, by means of the movement unit 26, along the movement axis 30 of the lift unit 18 that runs transversal, in particular at least substantially perpendicular, to the lifting direction 20 of the lift unit 18. In at least one method step 102 of the method 46, the containers 12, in particular the container stacks, are transported by means of the lift unit 18 along the lifting direction 20, in particular to the container pick-up unit 70.

Further method steps of the method 46, like for example a transfer of the containers 12, in particular the container stacks, to the container pick-up unit 70, a delivery of the containers 12, in particular the container stacks, from the container pick-up unit 70 to a transport device of the production machine 44, a filling of the containers 12 by means of the metering and/or filling device 14, or other method steps, deemed expedient by someone skilled in the art, are also conceivable. In particular, further method steps of the method 46 may be derived from the description of FIGS. 1 to 7 for the method 46.

1. A container feeding device for feeding containers (12) to a metering and/or filling device (14), the container feeding device comprising:
at least one magazine unit (16) for receiving a plurality of containers (12),
at least one lift unit (18) for a transport of the containers (12) along a lifting direction (20) of the at least one lift unit (18)
and at least one movement unit (26) which supports the at least one lift unit (18) such that the at least one lift unit (18) is movable relative to the at least one magazine unit (16) along a movement axis (30) of the at least one lift unit (18) that runs transverse to the lifting direction (20).

2. The container feeding device according to claim 1, wherein the movement axis (30) of the at least one lift unit (18), along which the at least one lift unit (18) is supported so as to be movable relative to the at least one magazine unit (16), is oriented with an inclination relative to a horizontal plane (32).

3. The container feeding device according to claim 1, wherein the at least one movement unit (26) comprises at least one drive (36) by which the at least one lift unit (18) is actively movable along the movement axis (30) of the at least one lift unit (18) relative to the at least one magazine unit (16).

4. The container feeding device according to claim 1, wherein the at least one lift unit (18) comprises at least one movably supported lateral guide element (38, 40), which is configured for at least partially encompassing or covering the containers (12) in a state when the containers (12) are arranged in the at least one lift unit (18).

5. The container feeding device according to claim 1, wherein the at least one lift unit (18) comprises at least one movably supported lateral guide element (38, 40), a movement axis (42) of which runs transverse to the movement axis (30) of the at least one lift unit (18).

6. A production machine with at least one container feeding device according to claim 1.

7. A method for feeding containers (12) to a metering and/or filling device (14) by a container feeding device, wherein a lift unit (18) of the container feeding device is moved by a movement unit (26) relative to a magazine unit (16) of the container feeding device along a movement axis (30) of the lift unit (18) that runs transverse to a lifting direction (20) of the lift unit (18).

8. The method according to claim 7, wherein the lift unit (18) is actively moved by at least one drive (36) of the movement unit (26) up to a proximity region (48) of a movably supported stopper element (50) of the magazine unit (16), and/or up to a proximity region (48) of a transport element (24) of the magazine unit (16).

9. The method according to claim 7, wherein at least one lateral guide element (38, 40) of the lift unit (18), which is configured for at least partially sidewise encompassing the containers (12) in a state when the containers (12) are arranged in the lift unit (18), is moved actively.

10. The method according to claim 7, wherein at least one lateral guide element (38) of the lift unit (18) and a further lateral guide element (40) of the lift unit (18) are moved actively in opposed directions.
